(19) United States
(12) Patent Application Publication
(10) Pub. No.: US 2018/0215651 A1
(43) Pub. Date: Aug. 2, 2018

(54) CHEMICALLY STRENGTHENED GLASS

(71) Applicant: ASAHI GLASS COMPANY, LIMITED, Tokyo (JP)

(72) Inventors: Shusaku AKIBA, Tokyo (JP); Akio KOIKE, Tokyo (JP)

(73) Assignee: ASAHI GLASS COMPANY, LIMITED, Tokyo (JP)

(21) Appl. No.: 15/894,624

(22) Filed: Feb. 12, 2018

Related U.S. Application Data
(63) Continuation of application No. PCT/JP2016/071792, filed on Jul. 26, 2016.

(30) Foreign Application Priority Data
Aug. 11, 2015 (JP) 2015-158843

(51) Int. Cl. C03C 3/087; C03C 3/085; C03C 4/18

(52) U.S. Cl. CPC C03C 3/087; C03C 2204/00; C03C 4/18; C03C 3/085

(57) ABSTRACT

Provided is a chemically strengthened glass having a sheet thickness of less than 300 μm, having a surface compressive stress of 200 MPa or more and satisfying CT≤4×(t/1000+0.02)⁻²+90, in which an internal tensile stress is CT (MPa) and the sheet thickness is t (μm).

### CROSS REFERENCE TO RELATED APPLICATIONS

This application is a continuation application of PCT/JP2016/071792 filed on Jul. 26, 2016, the text of which is incorporated by reference, and claims foreign priority to JP 2015-158843, filed on Aug. 11, 2015, the entire text of which is incorporated by reference.

### TECHNICAL FIELD

The present invention relates to chemically strengthened glass.

### BACKGROUND ART

A so-called chemically strengthened glass is used as a cover member in various uses such as electronic instruments represented by a smart phone and an electronic paper, automotive display members provided inside automobiles and electric trains, solar cell modules, and lightings. In recent years, a thickness of glass is becoming to be decreased for the purpose of weight reduction of instruments or the like using glass.

Patent Document 1 discloses a method of controlling fragility of strengthened glass by defining central tension (that is, internal tensile stress) CT inside glass and setting the value of CT to a certain numerical range. In this method, a function of a thickness called nonlinear critical central tension CT₁ (unit is MPa) is defined as “CT₁=−38.7×ln(t)+48.2” (Formula (1)) based on Examples of aluminosilicate glasses having a sheet thickness t of 0.3 to 1.5 mm, is disclosed as the upper limit of the value of the internal tensile stress CT and is considered as the critical value of the beginning of unacceptable fragility. In specific uses in which a glass sheet having small sheet thickness is used, design flexibility is restricted based on the formula (1).

### PRIOR ART DOCUMENTS

### Patent Document

Patent Document 1: JP-A-2011-530470

### SUMMARY OF THE INVENTION

### Problems that the Invention is to Solve

The present invention has an object to provide a chemically strengthened glass that does not finely fragment when the glass was broken even if a surface compressive stress or a depth of a compressive stress layer is increased than a conventional one under conditions where warpage is difficult to occur, even in a glass having particularly small sheet thickness.

### Means for Solving the Problems

Specifically, the present invention provides a chemically strengthened glass having a sheet thickness of less than 300 μm, having a surface compressive stress of 200 MPa or more and satisfying CT≤4×(t/1000+0.02)⁻²+90, in which an internal tensile stress is CT (MPa) and the sheet thickness is t (μm).

### Advantageous Effects of the Invention

According to the present invention, a chemically strengthened glass that does not finely fragment even when the glass has broken even if strength is increased than a conventional one under conditions where warpage is difficult to occur, even in a glass having particularly small sheet thickness.

### BRIEF DESCRIPTION OF THE DRAWINGS

FIG. 1 is a schematic view illustrating stress distribution in a sheet thickness direction in a case where warpage is not generated in the chemically strengthened glass according to the present embodiment.

FIG. 2 is a schematic view illustrating stress distribution in a sheet thickness direction in a case where warpage causing a depression on the surface is generated in the chemically strengthened glass according to the present embodiment.

FIG. 3 is a schematic view illustrating that the chemically strengthened glass according to the present embodiment is brought into contact with a material to be covered through an adhesive layer.

FIG. 4 is another schematic view illustrating that the chemically strengthened glass according to the present embodiment is brought into contact with a material to be covered.

FIG. 5 is a view explaining an observation method of the number of fragments of the chemically strengthened glass according to the present embodiment.

FIG. 6 is a view explaining the relationship between sheet thicknesses of the chemically strengthened glasses of Examples 1 to 41 and the value of CT and the value of CT₄.

FIG. 7 is a photograph of observation of the state after pressing an indenter having a tip angle of 60° in the chemically strengthened glass of Example 42 in a rate of 60 μm/sec.

FIG. 8 is a photograph of observation of the state after pressing an indenter having a tip angle of 60° in the chemically strengthened glass of Example 43 in a rate of 60 μm/sec.

FIG. 9 is a photograph of observation of the state after pressing an indenter having a tip angle of 60° in the chemically strengthened glass of Example 44 in a rate of 60 μm/sec.

FIG. 10 is a photograph of observation of the state after pressing an indenter having a tip angle of 60° in the chemically strengthened glass of Example 45 in a rate of 60 μm/sec.

FIG. 11 is a photograph of observation of the state after pressing an indenter having a tip angle of 60° in the chemically strengthened glass of Example 46 in a rate of 60 μm/sec.

FIG. 12 is a photograph of observation of the state after pressing an indenter having a tip angle of 60° in the chemically strengthened glass of Example 47 in a rate of 60 μm/sec.

### MODE FOR CARRYING OUT THE INVENTION

The embodiment for carrying out the invention is described below by reference to the drawings. In each drawing, the same reference numerals and signs are allotted to the same constituent parts, and overlapped descriptions are omitted in some cases.

<Chemically Strengthened Glass>

As described before, reduction in sheet thickness of glass is proceeding in recent years, and the value of internal tensile stress CT depending on a sheet thickness t tends to increase. Furthermore, glass has decreased bending rigidity and tends to extremely warp as the reduction in sheet thickness of glass sheet proceeds. The bending rigidity of a glass sheet can be obtained by the following formula (2).

$$\begin{matrix}[ Math . 1 ] & \\ D = \frac{E \cdot {t}^{3}}{12 ( 1 - {υ}^{2} )} & ( 2 )\end{matrix}$$

Here, D is bending rigidity (unit: N-mm) of a glass sheet, t is a sheet thickness (unit: mm) of a glass sheet, E is Young's modulus (unit: N·mm⁻²) of a glass sheet, and ν is Poisson's ratio (no unit, dimensionless) of a glass sheet. It is understood from the formula (2) that the bending rigidity D is in proportion to the cube of the sheet thickness t and glass is easy to extremely warp as the reduction in sheet thickness of glass sheet proceeds.

Conventionally, chemically strengthened glasses having a sheet thickness t of 300 μm or more have been controlled by, for example, the upper limit of the value of internal tensile stress CT as in the formula (1) of Patent Document 1. The upper limit of the value of internal tensile stress CT in chemically strengthened glasses having a sheet thickness t of less than 300 μm has not entirely been considered or is assumed to have similar behavior as the chemically strengthened glasses having a sheet thickness t of 300 μm or more.

However, particularly in glass having small sheet thickness t, bending rigidity is extremely small as indicated in the formula (2), and the influence by warpage cannot be disregarded. For example, when chemically strengthened glass having a sheet thickness t of less than 300 μm collides with an object and breaks, the object gives a crack to a certain point P on the front side of the glass, and simultaneously warpage of the chemically strengthened glass in which the front side of the glass becomes a depressed shape is generated as the point P being the vertex by stress when the object collided.

The present inventors have focused on the following points.

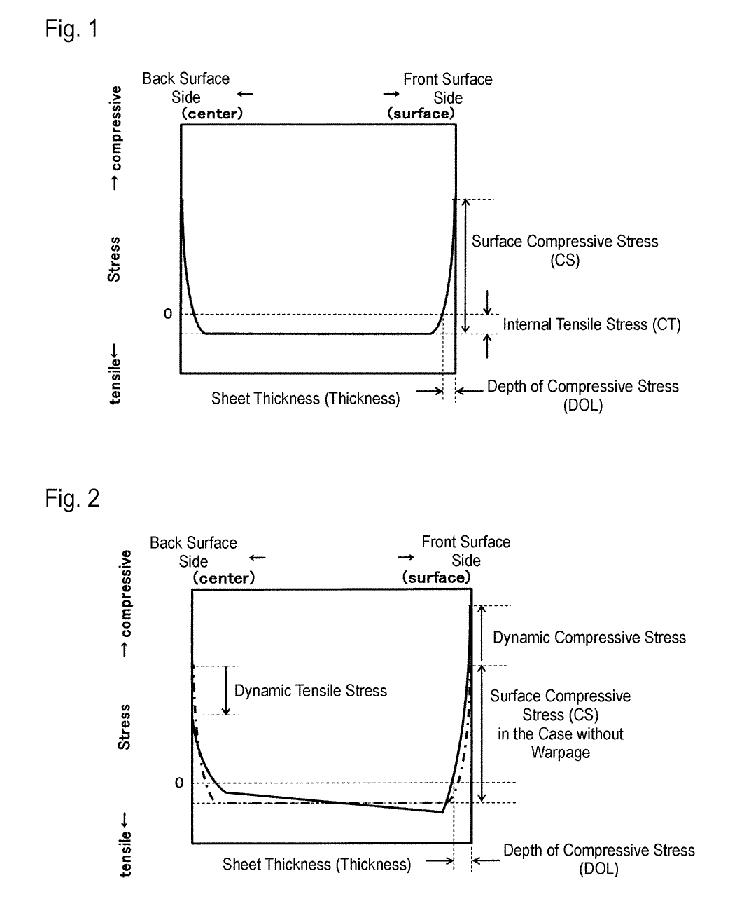

FIG. 1 is a schematic view of stress distribution in a sheet thickness direction in a case where warpage is not generated in the chemically strengthened glass. If warpage is not generated, stress distribution is nearly line-symmetrical between the front and back of the glass. In a case where warpage is generated in the chemically strengthened glass, in addition to surface compressive stress CS of a compressive stress layer by chemical strengthening, compressive stress by warpage is newly added to the front side of the point P. On the other hand, tensile stress by warpage is newly added to the back side of the point P. In the present description, compressive stress and tensile stress newly added by warpage are hereinafter called dynamic compressive stress and dynamic tensile stress, respectively. Therefore, when the state in which warpage is generated is compared with the state in which warpage is not generated (flat state), stress distribution in a sheet thickness direction differs due to the dynamic compressive stress and dynamic tensile stress.

FIG. 2 illustrates a schematic view of stress distribution in a sheet thickness direction of the chemically strengthened glass in a case where warpage causing concave surface on the front surface side is generated. The present inventors have thought that this peculiar stress distribution is present in not only the compressive stress layer of a surface layer but also the tensile stress layer inside the glass. Specifically, the present inventors have thought that tensile stress is relatively increased in a tensile stress layer near the front side (concave surface) where dynamic compressive stress is generated in the compressive stress layer, and on the other hand, tensile stress is relatively decreased in a tensile stress layer near the back side (convex surface) where dynamic tensile stress is generated in the compressive stress layer. In other words, when compared with internal tensile stress CT in the state that warpage is not generated, CT substantially increases in the vicinity of the concave surface and CT substantially decreases in the vicinity of the convex surface in the state that warpage is generated.

From the above, the present inventors have found that in chemically strengthened glasses having particularly small sheet thickness t, cracking behavior of the glass greatly differs by the influence of warpage when glass breaks (the viewpoint 1).

The chemically strengthened glass according to the present embodiment can be used in various uses, but the present inventors have focused on that the warpage thereof greatly differs depending on how the chemically strengthened glass is used.

Specifically, they have found that, for example, even in a case where it is used as a cover member in electronic instruments such as a smart phone, cracking behavior greatly differs between the case where an air layer (air gap) is present between a casing and the cover member and the case where the air layer is not present and the cover member is directly brought into contact with or is stuck to the casing by a transparent adhesive layer or the like.

Particularly, in recent years, not limited to electronic instruments, for the purpose of thickness reduction and size reduction or for improving visibility and transmittance, uses in which the cover member is directly brought into contact with or stuck to a material to be covered tend to be increased. The chemically strengthened glass according to the present embodiment can be used in cover glass and touch sensor glass of a touch panel display provided in information instruments such as tablet PC, note PC, smart phone, and digital book reader, cover glass of liquid crystal television, PC monitor and the like, cover glass of automobile instrument panels and the like, cover glass for solar cells, an interior material of building materials, and multilayer glass used in windows of buildings and housings. The above tendency is the common in many uses.

The present inventors have found that in the uses in which the cover member is directly brought into contact with or stuck to a material to be covered, a state that warpage is difficult to be generated is obtained as compared with a conventional state that adhesion between the cover member and a material to be covered is low (the viewpoint 2).

The present inventors have found based on the above viewpoints 1 and 2 that in the environment such that chemically strengthened glass having particularly thin thickness is directly brought into contact with a material to be covered, warpage is difficult to be generated, tensile stress in the vicinity of the defection spot is not increased in such a case, and as a result, the glass does not become fragile (that is, does not break finely) even though internal tensile stress CT (in warpage-free state) is increased to the value higher than a conventional value. Based on this, the present inventors have reached to complete the present invention.

<Shape and Physical Property of Chemically Strengthened Glass>

The chemically strengthened glass according to the present embodiment generally has a plate shape, but may be a flat sheet or a glass sheet having been subjected to bending. The chemically strengthened glass according to the present embodiment is a glass sheet formed into a flat sheet shape by a conventional glass forming processes such as a float process, a fusion process, a slot downdraw process, or the like, and preferably has a liquid phase viscosity of 130 dPa·s or more.

The chemically strengthened glass according to the present embodiment has a size formable by the conventional forming methods. Specifically, when formed by a float process, continuous ribbon-shaped glass having a float forming width is obtained. The chemically strengthened glass according to the present embodiment is finally cut into a size suitable for intended uses.

The sheet thickness t of the chemically strengthened glass according to the present embodiment is less than 300 μm for contributing to weight reduction. The chemically strengthened glass having the sheet thickness t of less than 300 μm is particularly easy to warp as indicated in the formula (2). When glass that is easy to warp is made to be a warpage-difficult state, it does not become fragile even though the internal tensile stress CT is increased to a value higher than a case where it conventionally warped. The sheet thickness t is more preferably less than 260 μm, less than 200 μm, less than 180 μm, less than 150 μm, less than 130 μm, and less than 100 μm.

It is preferred that the sheet thickness t of the chemically strengthened glass according to the present embodiment is 10 μm or more in order to provide the compressive stress layer deeper to a certain extent. In a chemically strengthened glass having a sheet thickness t of 10 μm or more, at least the depth of the compressive stress layer DOL (hereinafter simply referred to as DOL) can be 3 μm or more. The sheet thickness t is more preferably 20 μm or more, 30 μm or more and 50 μm or more. To obtain larger DOL, it is preferred that the sheet thickness t is 70 μm or more. By this, the glass can be prevented from being broken from the edge surface when it is greatly bent.

The maximum error of the sheet thickness t, that is, the difference between the thickness in the thickest portion and the thickness in the thinnest portion in the sheet thickness, is preferably 10% or less of the sheet thickness t. When the maximum error of the sheet thickness is large, the tensile stress is locally increased in the plane when external force is applied, and there is a possibility that the glass becomes easy to break. The maximum error of the sheet thickness t is more preferably 5% or less.

The chemically strengthened glass according to the present embodiment can be used in cover glass and touch sensor glass of a touch panel display provided in information instruments such as tablet PC, note PC, smart phone, and digital book reader, cover glass of liquid crystal television, PC monitor and the like, cover glass of automobile instrument panels and the like, a cover glass for solar cells, an interior material of building materials, and multilayer glass used in windows of buildings and housings. Therefore, it has a size according to each of the uses, such as a size of a display of tablet PC, smart phone or the like, or a size of cover glass for solar cells.

The size of chemically strengthened glass is not particularly limited as described before, but for example, it is preferred that the surface area of the main surface is 40000 mm² or more. The adhesion to a conventional material to be covered is difficult to maintain as the size of the glass is large, and glass have conventionally been used in the state where warpage is easy to occur. Therefore, the effect of the present invention is remarkable. The surface area is more preferably 90000 mm² or more, and still more preferably 250000 mm² or more.

The chemically strengthened glass according to the present embodiment is generally cut into a rectangle, but may be other shapes such as a circle and a polygon without any problem, and includes glass having been subjected to hole-coring.

The chemically strengthened glass according to the present embodiment has a compressive stress layer on the surface thereof by an ion exchange treatment. The surface compressive stress (CS) of the chemically strengthened glass is preferably 200 MPa or more, and is more preferably 300 MPa or more, 400 MPa or more, 500 MPa or more, 600 MPa or more, 700 MPa or more, 800 MPa or more, 900 MPa or more, and 1000 MPa or more. When the CS is 200 MPa or more, cracks are difficult to be generated on the glass surface.

When cracks having a depth exceeding the value of DOL are generated during the use of the chemically strengthened glass, this leads to the fracture of the chemically strengthened glass. Therefore, deeper DOL of the chemically strengthened glass is preferred. The DOL is preferably 3 μm or more, and is more preferably 4 μm or more, 5 μm or more, 6 μm or more, 7 μm or more, 8 μm or more, and 9 μm or more.

On the other hand, when the DOL is 50 μm or less, the chemically strengthened glass can be easily cut. The DOL is more preferably 40 μm or less, 30 μm or less, 20 μm or less, 15 μm or less, 12 μm or less, 10 μm or less, and less than 10 μm.

The internal tensile stress (hereinafter simply referred to as CT) of the chemically strengthened glass of the present embodiment can be calculated by “CT=CS×DOL/(t−2×DOL)” (Formula (3)). Here, t is a sheet thickness (μm) of glass, DOL is a depth (μm) of a compressive stress layer, and CS is a surface compressive stress value (MPa).

The internal tensile stress CT of the chemically strengthened glass in warpage-free state can increase CS and can make DOL deeper when the value of the internal tensile stress CT of the chemically strengthened glass is increased, and this is preferred. In other words, when CS or DOL is tried to be increased, CT is necessarily increased. For example, in glass having similar stress profile, when the value of CS or DOL is increased 10% (the value is increased to 1.1 times), the value of CT is generally increased about 10%. Therefore, CS and DOL can be approached to the more preferred values by increasing the value of CT.

When the internal tensile stress CT of the chemically strengthened glass according to the present embodiment satisfies CT≤4×(t/1000+0.02)⁻²+90 [MPa] (Formula (4)), the glass becomes difficult to finely fragment when broken in warpage-free state. Here, t is a sheet thickness (μm), and the value of CT₄, that is, the value of the right side of the formula (4), is the upper limit of the internal tensile stress CT in the state that the chemically strengthened glass does not warp, found as a result of intensive investigations by the inventors of the present application. In the chemically strengthened glass that is easy to warp, in which the sheet thickness t is less than 300 μm, strength of the chemically strengthened glass can be controlled by controlling the internal tensile stress CT within the numerical range satisfying the formula (4). The basis of the value of CT₄ is described hereinafter.

The internal tensile stress CT of the chemically strengthened glass according to the present embodiment is preferably 30 MPa or more, and is more preferably 50 MPa or more, 70 MPa or more, 100 MPa or more, 120 MPa or more, 150 MPa or more, and 200 MPa or more, in order to approach CS and DOL to the more preferred values. Furthermore, it is preferred that the internal tensile stress CT is larger than the CT₁ value defined by the formula (1) in order to enable material design different from a conventional one for suitably increasing CS and DOL.

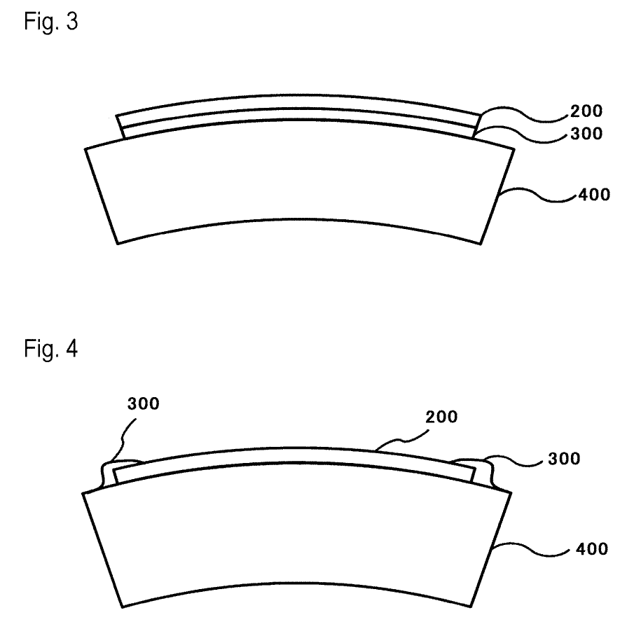

As described before, even in the thin chemically strengthened glass having the sheet thickness t of less than 300 μm, by using the glass in the environment such that it is brought into contact with a material to be covered, warpage is difficult to be generated and the effect of the present invention is easy to be exhibited, which is preferred. FIG. 3 illustrates the example that chemically strengthened glass 200 of the present embodiment is brought into contact with a material 400 to be covered, through an adhesive layer 300. It is preferred that the chemically strengthened glass of the present embodiment is used by being brought into contact with, through an adhesive layer, a material to be covered having bending rigidity D obtained by the formula (2) larger than that of chemically strengthened glass. By this, the glass becomes difficult to warp, and as a result, it becomes difficult to finely fragment when broken even in a case where the internal tensile stress CT is high. More preferably, the bending rigidity D of the material to be covered is 2 times or more, 3 times or more, 5 times or more, 10 times or more, and 100 times or more, higher than the bending rigidity D of the chemically strengthened glass.

The resin contained in the adhesive layer may be any one so long as the adhesive layer can adhere to the material to be covered, and a conventional adhesive compositions generally used can be used. Examples thereof include an acrylic resin, a urethane resin, a silicone resin, a phenol resin, an epoxy resin, a melamine resin, a urea resin, an unsaturated polyester resin, an alkyd resin, a polyimide resin, and a fluororesin. The adhesive composition may be a copolymer resin (copolymer) in which several kinds of monomers have been polymerized, and may be a mixture of several kinds of resins. Of those, an acrylic resin and a silicone resin have excellent heat resistance, peeling resistance and transparency, and are therefore preferable.

In the case of an environment that the chemically strengthened glass is brought into contact with the material to be covered, the adhesive layer 300 may not always be brought into contact with the entire surface of the material to be covered, and may be brought into contact with only a part of the material to be covered. FIG. 4 illustrates another example that the chemically strengthened glass 200 of the present embodiment is brought into contact with the material 400 to be covered. As illustrated in FIG. 4, it is sufficient only if the adhesive layer 300 is provided so as to fix the edge part of the chemically strengthened glass 200. Transmittance at the central part of the chemically strengthened glass 200 is increased by this. Furthermore, in the case of fixing as in FIG. 4, the adhesive layer does not always contain a resin, and fixing can be performed by an optional material so long as it has a function of bring the chemically strengthened glass into contact with the material to be covered.

The chemically strengthened glass of the present embodiment can be used by being brought into contact with or being adhered to the material to be covered, but may be used for the purpose of, for example, suppressing crack in a part of a production process. For example, after once having been brought into contact with or adhered to the material to be covered, the chemically strengthened glass can be separated from the material to be covered and used as simple chemically strengthened glass.

The chemically strengthened glass of the present embodiment has flexibility and therefore can be brought into contact with the surface of the material to be covered other than a plane. For example, a surface curvature radius of the material to be covered with which the chemically strengthened glass is brought into contact is preferably 10000 mm or less in uses requiring design, and more preferably 1000 mm or less. In the same uses, a curvature radius of the main surface of the chemically strengthened glass of the present embodiment is preferably 10000 mm or less, and more preferably 1000 mm or less. When a curvature radius of the main surface of the chemically strengthened glass is 30 mm or more, the influence by dynamic compressive stress is not excessively large and this is preferable.

(Glass for Chemical Strengthening)

The composition of glass for chemical strengthening used for manufacturing the chemically strengthened glass of the present embodiment is described by using the content expressed by mol % on the basis of oxides, unless otherwise indicated.

SiO₂ is known as a component of forming a network structure in glass microstructure. The content of SiO₂ is preferably 64% or more, and is more preferably 65% or more, 66% or more and 67% or more. The content of SiO₂ is preferably 72% or less, and is more preferably 71.5% or less and 71% or less. The content of SiO₂ of 65% or more is advantageous in stability and weatherability as glass. On the other hand, the content of SiO₂ of 72% or less is advantageous in meltability and formability.

Al₂O₃ has an action of improving ion exchangeability in chemical strengthening, and particularly the action of improving CS is large. It is also known as a component of improving weatherability of glass. It further has the action suppressing invasion of tin from a bottom surface contacting a tin bath in conducting float forming using the tin bath. The content of Al₂O₃ is preferably 1% or more, is more preferably 1.5% or more, 2% or more, 2.5% or more, 3% or more, and is still more preferably 3.4% or more. The content of Al₂O₃ is preferably 9% or less, and is more preferably 8% or less, 7% or less, 6% or less, 5% or less, and 4% or less. When the content of Al₂O₃ is 1% or more, the desired CS value is obtained by ion exchange, and furthermore, the effect of suppressing invasion of tin, the effect of stability to the change of an amount of moisture and dealkalization acceleration effect are obtained. On the other hand, the content of Al₂O₃ of 9% or less is advantageous in that DOL value does not excessively increase and CT value can be suppressed to a fixed value or less.

MgO is a component of stabilizing glass. The content of MgO is preferably 1% or more, and is more preferably 2% or more, 3% or more and 4% or more. The content of MgO is preferably 12% or less, and is more preferably 11% or less, 10% or less, 9% or less, 8% or less, and 7% or less. When the content of MgO is 1% or more, meltability at high temperature is improved, and devitrification is difficult to occur. On the other hand, when the content of MgO is 11% or less, devitrification is difficult to occur and sufficient ion exchange rate is obtained.

CaO is a component of stabilizing glass. When CaO is contained, the content thereof is preferably 3% or more, and is more preferably 4% or more, 5% or more, more than 5%, 6% or more, and 7% or more. The content of CaO is preferably 10% or less, and is more preferably 9% or less and 8% or less. Particularly when the content of CaO is more than 5%, DOL value does not excessively increase and CT value can be suppressed to a fixed value or less. On the other hand, when the content of CaO is 9% or less, sufficient ion exchange rate is obtained, and the desired DOL value is obtained.

Na₂O is a component of forming a compressive stress layer by ion exchange, and has the action of deepen DOL. Furthermore, it is a component of decreasing high temperature viscosity and devitrification temperature of glass and improving meltability and formability of glass. Na₂O is a component generating non-bridge oxygen (NBO), and moisture in glass is a component of generating non-bridge oxygen. For this reason, when Na₂O is contained in glass in a fixed amount or more, variation of properties of glass due to variation of the amount of non-bridge oxygen when the amount of moisture in glass has changed, for example, variation of chemical strengthening property, is decreased. The content of Na₂O is preferably 10% or more, and is more preferably 11% or more, 12% or more and 13% or more. The content of Na₂O is preferably 18% or less, and is more preferably 17% or less and 16% or less. When the content of Na₂O is 10% or more, the desired compressive stress layer can be formed by ion exchange, and variation to the change of the amount of moisture can be suppressed. On the other hand, when the content of Na₂O is 18% or less, sufficient weatherability is obtained, the invasion amount of tin from a bottom surface when performing float forming can be suppressed, and glass can be made difficult to curve after a chemical strengthening treatment.

The total content of SiO₂, Al₂O₃, MgO, CaO, and Na₂O is preferably 98% or more. When the total content is less than 98%, the desired compressive stress layer may be difficult to obtain while maintaining crack resistance. It is more preferably 98.3% or more, 98.7% or more and 99% or more.

K₂O has the effect of increasing an ion exchange rate and deepening DOL, and is a component of increasing non-bridge oxygen. Therefore, when K₂O is contained, it is preferably 5% or less, and is more preferably 4% or less, 3% or less, 2% or less, 1% or less, 0.8% or less, and 0.6% or less. Particularly, when it is 1% or less, DOL does not excessively become deep, and sufficient CS is obtained. A small amount of K₂O has the effect of suppressing invasion of tin from a bottom surface when conducting float forming. Therefore, it is preferred to be contained when conducting float forming. In this case, the content of K₂O is preferably 0.05% or more, and more preferably 0.1% or more.

As described above, Al₂O₃ has the action of improving CS, whereas Na₂O has the action of deepening DOL and decreasing CS. K₂O has the action of increasing an ion exchange rate and deepening DOL. Therefore, when Al₂O₃, Na₂O and K₂O are contained in specific proportions, it is possible to increase the value of CS and cut after a chemical strengthening treatment. From this standpoint, the ratio of (Na₂O+K₂O)/Al₂O₃ is 5 or less, preferably 4.5 or less, and more preferably 4 or less.

Al₂O₃ is also a component of increasing high temperature viscosity and devitrification temperature, and Na₂O and K₂O are also components of decreasing those. When (Na₂O+K₂O)/Al₂O₃ is 1.8 or more, high temperature viscosity is decreased and devitrification temperature is decreased. Furthermore, DOL can be made sufficient depth. Al₂O₃ is a component of decreasing non-bridge oxygen, and Na₂O and K₂O are components of increasing it. To stably manufacture glass, maintain DOL necessary to improve strength and obtain stable chemical strengthening property to the change of the amount of moisture, the ratio of (Na₂O+K₂O)/Al₂O₃ is preferably 1.8 or more, more preferably 2.2 or more, and still more preferably 2.4 or more.

When glasses having the same matrix composition and different amount of moisture are subjected to chemical strengthening, the value of CS decreases with increasing the amount of moisture, and the value of DOL slightly decreases with increasing the amount of moisture and does not greatly depend thereon. When the content of Na₂O or K₂O in glass increases, the change of CS when the amount of moisture changes decreases. This is considered to be because that non-bridge oxygen in glass increases and the influence of the increase and decrease of the amount of non-bridge oxygen by the change of the amount of moisture is reduced. On the other hand, when the content of Al₂O₃ increases, the non-bridge oxygen in glass decreases. To obtain stable chemical strengthening property regardless of the amount of moisture in glass containing 1% or more of Al₂O₃, it is preferred that the ratio of (Na₂O+K₂O)/Al₂O₃ is 1.8 or more.

In glass formed by a float process, the content of Al₂O₃ in the glass affects invasion of tin, and Al₂O₃ component has the action of suppressing invasion of tin when it increases. Furthermore, the content of an alkali component, that is, Na₂O, affects invasion of tin, and the alkali component has the action of increasing invasion of tin. Therefore, by maintaining the value of Na₂O/Al₂O₃ in an appropriate range, tin invasion in the forming by a float process is suppressed, and warpage of glass after chemical strengthening can be reduced.

Paying attention to two components of Al₂O₃ and Na₂O, those have contrary actions in CS and DOL, high temperature viscosity, devitrification temperature, and invasion amount of tin from a bottom surface. It is preferred to contain Al₂O₃ and Na₂O in a specific ratio, and to improve the value of CS and to reduce invasion amount of tin, Na₂O/Al₂O₃ is preferably 5 or less, more preferably 4.5 or less, and still more preferably 4 or less. On the other hand, to maintain DOL necessary for improving strength and to suppress the increase of high temperature viscosity and devitrification temperature, Na₂O/Al₂O₃ is preferably 1.8 or more, more preferably 2 or more, and still more preferably 2.4 or more.

TiO₂ much exists in natural raw materials, and it is known to be color source of yellow. The content of TiO₂ is 0.2% or less, preferably 0.13% or less, and more preferably 0.1% or less. When the content of TiO₂ exceeds 0.2%, glass shows yellowish color. The lower limit of TiO₂ content is desirably 0%.

Fe₂O₃ is present everywhere of the natural world and production line. Therefore, it is a component that is extremely difficult to make the content thereof zero. It is known that Fe₂O₃ in an oxidized state causes yellow coloration and FeO in a reduced state causes blue coloration, and it is known that glass colors in green by the balance of those. When the glass of the present embodiment is used in a display, window glass, cover glass of solar cells, and like, it is preferred that the coloration is small. Total iron amount (total Fe) is converted as Fe₂O₃, and the content thereof is preferably 0.15% or less, more preferably 0.13% or less, and still more preferably 0.11% or less. It is desirably 0%.

SO₃ is a fining agent used in melting glass raw materials and forming glass. Generally, the content thereof in glass is a half or less of the amount thereof supplied from raw materials. The content of SO₃ in glass is 0.02% or more, preferably 0.05% or more, and more preferably 0.1% or more. The content of SO₃ is 0.4% or less, preferably 0.35% or less, and more preferably 0.3% or less. When the content of SO₃ is 0.02% or more, refining is sufficient and bubble defects can be suppressed. On the other hand, when the content of SO₃ is 0.4% or less, the defect of sodium sulfate formed in glass can be suppressed.

Other than the above, a chloride, a fluoride and the like may be appropriately contained as a fining agent. The glass of the present invention substantially composed of the components described above, but other components may be contained in a range that does not impair the object of the present invention. When such components are contained, the total content of the components is preferably 5% or less, more preferably 3% or less, and typically 1% or less. The other components are exemplarily described below.

It is known that ZrO₂ generally has the action of increasing surface compressive stress in chemical strengthening. However, even though a small amount of ZrO₂ is contained, its effect is not large for cost increase. Therefore, ZrO₂ can be contained in optional proportion in a range that the cost is acceptable. When contained, it is preferably 1% or less.

SrO and BaO may be contained in small amounts for the purpose of decreasing high temperature viscosity of glass and decreasing devitrification temperature of glass. SrO or BaO has the action of decreasing an ion exchange rate. Therefore, when contained, it is preferably 0.5% or less as SrO or BaO.

ZnO may be contained in an amount of, for example, up to 2% in order to improve meltability at high temperature of glass. However, in the case of manufacturing by a float process, it is reduced in the float bath, leading to a product defect. Therefore, it is preferably less than 0.1%, and it is more preferably not substantially contained. The term “is not substantially contained” used herein means that it is not contained in an amount equal to or more than an amount contained as inevitable impurities in a manufacturing process.

B₂O₃ may be contained in a range of less than 1% in order to improve meltability at high temperature or glass strength. Generally, when an alkali component of Na₂O or K₂O and B₂O₃ are simultaneously contained, volatilization becomes violent, and a brick is remarkably corroded. Therefore, the content of B₂O₃ is preferably less than 0.5%, and more preferably less than 0.1%. It is further preferably not substantially contained.

Li₂O is a component of decreasing a strain point and easily causing stress relaxation, and as a result, a stabilized compressive stress layer is not obtained. Therefore, it is preferably not contained. Even when contained, the content thereof is preferably less than 1%, more preferably 0.05% or less, and particularly preferably less than 0.01%.

A chloride, a fluoride and the like may be appropriately contained as a fining agent in melting glass. However, to enhance visibility of a display device such as a touch panel, it is preferred that components mixed in as impurities of raw materials, such as Fe₂O₃, NiO and Cr₂O₃ having absorption in a visible region, should be reduced as possible. Each of those is preferably 0.15% or less, and more preferably 0.05% or less, in terms of mass percentage.

A method for manufacturing glass for chemical strengthening is not particularly limited. Desired glass raw materials are placed in a continuous melting furnace, the glass raw materials are heated and melted at preferably 1500 to 1600° C., and refined. Then, molten glass is formed into a sheet shape by providing in a forming apparatus and annealed. Thus, the glass for chemical strengthening can be manufactured.

Various methods can be used in the forming of the glass for chemical strengthening. For example, various forming methods such as a downdraw process (for example, overflow downdraw process, slot down process, redraw process, or the like), a float process, a rollout process, and press process can be used.

The sheet thickness t of the glass for chemical strengthening can be adjusted thin by slimming processing by an etching treatment. For example, a mixed acid having HF concentration of 1 to 5 mass % and HCl concentration of 1 mass % or more is used as an etching liquid, and the etching liquid is uniformly brought into contact with the entire surface of the glass for chemical strengthening by a dipping method, a spray method, a showering method, or the like. The glass for chemical strengthening is removed in a range of 1 to 300 μm from the surface thereof by the etching treatment, and the sheet thickness can be adjusted in units of 1 μm.

The glass for chemical strengthening used in the chemically strengthened glass according to the present embodiment is preferably subjected to slimming processing. The chemically strengthened glass obtained by chemically strengthening glass for chemical strengthening that is not subjected to slimming processing is that variation is present in the concentration of alkali metal ions (for example, Na⁺ and K⁺) on the surface. Therefore, the part that is difficult to be locally ion-exchanged is present in plane in the chemical strengthening treatment step. Therefore, reliability of surface strength of the chemically strengthened glass thus obtained is low. The concentration of alkali metal ions on the surface can be made uniform by conducting slimming processing, and as a result, reliability of surface strength of the chemically strengthened glass obtained is far improved.

Surface roughness Ra on the surface of the chemically strengthened glass that is not subjected to slimming processing is generally 0.2 to 0.5 nm, whereas the surface roughness Ra of the chemically strengthened glass chemically strengthened after being subjected to the slimming processing is 1 nm or more. It is preferred that the surface roughness Ra is 300 nm or less in order to not impair transparency and beauty.

The composition of the chemically strengthened glass according to the present embodiment may be considered to be the same as the composition of the glass for chemical strengthening described above. Na ions on the glass surface are ion-exchanged with K ions in an inorganic salt by the chemical strengthening described hereinafter, but this can be disregarded as the change of the entire composition.

(Chemical Strengthening Treatment)

By a chemical strengthening treatment, a glass substrate is brought into contact with a melt of an alkali metal salt (for example, potassium nitrate) containing alkali metal ions (typically K ions) having large ionic radius by dipping or the like, thereby metal ions (typically Na ions) having small ionic radius in the glass substrate are substituted with metal ions having large ionic radius. By this, compressive stress is generated on the glass surface by the difference in the area occupied by alkali metal ions, to form a compressive stress layer.

Treatment temperature and treatment time of contacting the glass with the molten salt containing alkali metal ions are appropriately adjusted depending on the composition of the glass and molten salt. The heating temperature of the molten salt is generally preferably 350° C. or higher, and more preferably 370° C. or higher. It is generally preferably 500° C. or lower, and more preferably 450° C. or lower. When the heating temperature of the molten salt is 350° C. or higher, chemical strengthening is prevented from being difficult to be effected by the decrease of an ion exchange rate. When it is 500° C. or lower, decomposition and degradation of the molten salt can be suppressed.

For example, the time for contacting aluminosilicate glass with the molten salt is generally preferably 1 hour or more, and more preferably 2 hours or more, in order to give sufficient surface compressive stress. For example, the time for contacting soda lime glass with the molten salt is preferably 3 hours or more, 4 hours or more, 5 hours or more, and 6 hours or more, in order to give deeper compressive stress layer. In the ion exchange for a long period of time, productivity drops, and additionally a surface compressive stress value decreases by relaxation. Therefore, in the case of the aluminosilicate glass, it is preferably 72 hours or less, and more preferably 24 hours or less and 8 hours or less. In the case of the soda lime glass, the time required in ion exchange is relatively long. Therefore, it is preferably 300 hours or less, and more preferably 200 hours or less and 100 hours or less.

Examples of the molten salt for conducting an ion exchange treatment include an alkali nitrate, an alkali sulfate and an alkali chloride, such as potassium nitrate, potassium sulfate, potassium carbonate, and potassium chloride. Those molten salts may be used alone or as mixtures of plural kinds thereof. A salt containing sodium (Na ions) or lithium (Li ions) may be mixed in order to adjust chemical strengthening property.

It is preferred that as the molten salt for conducting the ion exchange treatment, a treating salt containing at least potassium ions is used. Examples of the treating salt preferably include salts containing 50 mass % or more of potassium nitrate. A mixed molten salt may contain other components. Examples of the other components include alkali sulfates such as sodium sulfate and potassium sulfate, and alkali chlorides such as sodium chloride and potassium chloride.

In the chemically strengthened glass according to the present embodiment, the treatment conditions of the chemical strengthening treatment are not particularly limited, and optimum conditions can be selected considering properties of glass, a molten salt and the like.

The chemical strengthening treatment may be successively conducted on-line to a glass ribbon continuously moving in a continuous step, for example, a glass sheet production step, and may be discontinuously conducted on-line.

Uses of the chemically strengthened glass according to the present embodiment are not particularly limited. Due to having high mechanical strength, it is suitable for use in places expecting shock by drop and contact with other materials. For example, the chemically strengthened glass according to the present embodiment can be used in cover glass and touch sensor glass of a touch panel display provided in information instruments such as tablet PC, note PC, smart phone, and digital book reader, cover glass of liquid crystal television, PC monitor and the like, cover glass of automobile instrument panels and the like, cover glass for solar cells, an interior material of building materials, and multilayer glass used in windows of buildings and housings. Specifically, it has a size according to each of the uses, such as a size of a display of tablet PC, smart phone or the like, or a size of cover glass for solar cells.

### EXAMPLES

Examples corresponding to the chemically strengthened glass according to the present embodiment are described below.

### <Evaluation Methods>

Various evaluations in the Examples were conducted by the analysis methods described below.

### (Evaluation of Glass: Surface Stress)

### (Evaluation of Chemically Strengthened Glass: Cracking Behavior)

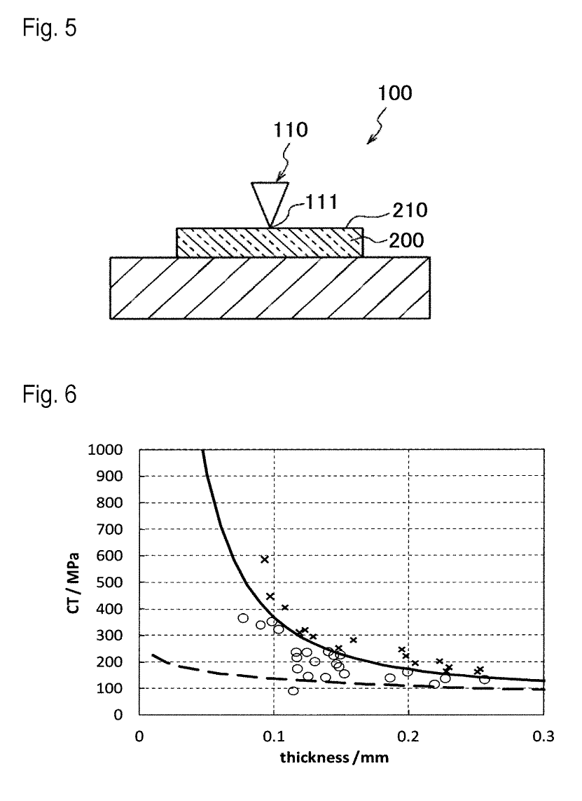

Cracking behavior of the chemically strengthened glass was evaluated as follows. The evaluation method is illustrated in a schematic view of FIG. 5. An indenter 110 was pressed in under static load conditions such that its tip 111 is vertical to a surface 210 of the chemically strengthened glass. As Vickers hardness tester 100 having the indenter 110 to be attached thereto, FLS-ARS9000 manufactured by Future-Tech Corp was used. As the indenter 110, one having a facing angle of the tip 111 of 60° was used. The indenter 110 was pressed such that a load of 1.0 kgf (about 9.8 N) is applied thereto in the surface 210 of the chemically strengthened glass in a rate of 60 μm/sec, and was maintained for 15 seconds in the state of having reached the load. The load of the indenter was then removed, and 15 seconds thereafter, the chemically strengthened glass 200 was observed. The number of broken pieces (the number of fragments) of the chemically strengthened glass 200 broken by this was calculated, and cracking behavior of the chemically strengthened glass 200 was evaluated.

### Examples 1 to 33

### (First Chemical Strengthening Step)

Aluminosilicate glasses (the compositions are shown below) having a sheet thickness of 330 μm were subjected to slimming processing by an etching treatment to obtain aluminosilicate glasses of 50 mm×50 mm×98 to 256 μm t. Potassium nitrate (KNO₃) and sodium nitrate (NaNO₃) were added to an SUS cup such that the total amount of those is 3500 g and the concentration (mass %) of KNO₃ is as shown in the item of the first chemical strengthening treatment in Table 1, and heated to a predetermined temperature by a mantle heater to prepare a mixed molten salt of potassium nitrate and sodium nitrate. The aluminosilicate glasses were preheated to 425° C., dipped in the molten salt for a predetermined time, subjected to an ion exchange treatment, and then cooled to the vicinity of room temperature. Thus, a chemical strengthening treatment was conducted. The conditions of the chemical strengthening treatment are shown in Table 1. The chemically strengthened glasses obtained were washed with pure water several times, and then dried by air blow. Thus, the chemically strengthened glasses of Examples 1 to 33 were obtained.

Aluminosilicate glass (specific gravity: 2.41) composition (mol % expression): SiO₂ 64.5%, Al₂O₃ 8%, Na₂O 12.5%, K₂O 4.0%, MgO 10.5%, ZrO₂ 0.5%

Each of the chemically strengthened glasses thus obtained was subjected to various evaluations. From CS value, DOL value and sheet thickness t (unit: μm) obtained by those evaluations, CT value based on the formula (3) was obtained. CT₁ value was obtained as CT₁=−38.7×ln(t/1000)+48.2 [MPa] from the sheet thickness t (unit: μm). The results are shown in Table 1.

TABLE 1

| | | Chemical strengthening step | | | | | | | | |
|---|---|---|---|---|---|---|---|---|---|---|
| | Sheet | KNO₃ | Strengthening | Strengthening | | | | | | Number of |
| | thickness t | concentration | time | temperature | CS | DOL | CT | CT₁ | CT₄ | fragments |
| | [μm] | [mass %] | [hour] | [° C.] | [MPa] | [μm] | [MPa] | [MPa] | [MPa] | [Number] |
| Ex. 1 | 117 | 100 | 2 | 375 | 801 | 18 | 178 | 131.2 | 303.1 | 9 |
| Ex. 2 | 116 | 100 | 3 | 375 | 786 | 22 | 240 | 131.6 | 306.3 | 10 |
| Ex. 3 | 124 | 100 | 4 | 375 | 759 | 24 | 240 | 129.0 | 282.9 | 10 |
| Ex. 4 | 108 | 100 | 5 | 375 | 702 | 29 | 407 | 134.3 | 334.1 | 1000 |
| Ex. 5 | 103 | 100 | 2 | 400 | 729 | 24.3 | 326 | 136.2 | 354.4 | 2 |
| Ex. 6 | 98 | 100 | 2.5 | 400 | 710 | 24.5 | 355 | 138.1 | 377.3 | 9 |
| Ex. 7 | 125 | 100 | 2 | 375 | 799 | 17 | 149 | 128.7 | 280.2 | 2 |
| Ex. 8 | 138 | 100 | 3 | 375 | 822 | 18 | 145 | 124.8 | 250.2 | 2 |
| Ex. 9 | 130 | 100 | 4 | 375 | 800 | 22 | 205 | 127.2 | 267.8 | 2 |
| Ex. 10 | 140 | 100 | 5 | 375 | 771 | 27 | 242 | 124.3 | 246.3 | 3 |
| Ex. 11 | 129 | 100 | 3 | 400 | 736 | 28.8 | 297 | 127.5 | 270.2 | 100 |
| Ex. 12 | 123 | 100 | 3.5 | 400 | 721 | 29 | 322 | 129.3 | 285.6 | 1000 |
| Ex. 13 | 146 | 100 | 4 | 400 | 796 | 24.1 | 196 | 122.7 | 235.2 | 3 |
| Ex. 14 | 144 | 100 | 4.5 | 400 | 774 | 26.7 | 228 | 123.2 | 238.7 | 10 |
| Ex. 15 | 152 | 100 | 4 | 375 | 778 | 22 | 158 | 121.1 | 225.2 | 3 |
| Ex. 16 | 148 | 100 | 5 | 375 | 772 | 24 | 185 | 122.1 | 231.7 | 3 |
| Ex. 17 | 149 | 100 | 6 | 375 | 810 | 27 | 230 | 121.9 | 230.1 | 2 |
| Ex. 18 | 148 | 100 | 7 | 375 | 789 | 29 | 254 | 122.1 | 231.7 | 100 |
| Ex. 19 | 159 | 100 | 8 | 375 | 771 | 33.7 | 284 | 119.4 | 214.8 | 1000 |
| Ex. 20 | 186 | 100 | 3 | 400 | 796 | 24.6 | 143 | 113.3 | 184.3 | 3 |
| Ex. 21 | 198 | 100 | 5 | 400 | 784 | 36 | 224 | 110.9 | 174.2 | 1000 |
| Ex. 22 | 195 | 100 | 6 | 400 | 778 | 38 | 248 | 111.5 | 176.5 | 1000 |
| Ex. 23 | 205 | 100 | 8 | 400 | 809 | 33.6 | 197 | 109.5 | 169.0 | 100 |
| Ex. 24 | 199 | 100 | 3 | 400 | 804 | 29 | 165 | 110.7 | 173.4 | 2 |
| Ex. 25 | 227 | 100 | 4 | 400 | 815 | 29.1 | 141 | 105.6 | 155.6 | 2 |
| Ex. 26 | 219 | 100 | 6 | 400 | 823 | 24.6 | 119 | 107.0 | 160.0 | 2 |
| Ex. 27 | 223 | 100 | 6 | 400 | 840 | 36.5 | 204 | 106.3 | 157.7 | 1000 |
| Ex. 28 | 23 | 100 | 5.5 | 400 | 797 | 36 | 182 | 105.1 | 154.0 | 1000 |
| Ex. 29 | 228 | 100 | 4.5 | 400 | 878 | 31.3 | 166 | 105.4 | 155.0 | 100 |
| Ex. 30 | 256 | 100 | 4 | 400 | 820 | 32 | 137 | 100.9 | 142.5 | 2 |
| Ex. 31 | 251 | 100 | 5 | 400 | 823 | 35.8 | 164 | 101.7 | 144.5 | 100 |
| Ex. 32 | 253 | 100 | 6 | 400 | 806 | 38.2 | 174 | 101.4 | 143.7 | 1000 |
| Ex. 33 | 114 | 100 | 1 | 375 | 782 | 11 | 94 | 110.9 | 174.2 | 10 |

### Examples 34 to 41

### (First Chemical Strengthening Step)

Soda lime glasses (the compositions are shown below) having a sheet thickness of 330 μm were subjected to slimming processing by an etching treatment to obtain soda lime glasses of 50 mm×50 mm×50 to 119 μm t. Potassium nitrate (KNO₃) and sodium nitrate (NaNO₃) were added to an SUS cup such that the total amount of those is 3500 g and the concentration (mass %) of KNO₃ is as shown in the item of the first chemical strengthening treatment in Table 1, and heated to a predetermined temperature by a mantle heater to prepare a mixed molten salt of potassium nitrate and sodium nitrate. The soda lime glasses were preheated to 425° C., dipped in the molten salt for a predetermined time, subjected to an ion exchange treatment, and then cooled to the vicinity of room temperature. Thus, a chemical strengthening treatment was conducted. The conditions of the chemical strengthening treatment are as shown in Table 1. The chemically strengthened glasses obtained were washed with pure water several times, and then dried by air blow. Thus, the chemically strengthened glasses of Examples 34 to 41 were obtained.

Soda lime glass (specific gravity: 2.50) composition (mol % expression): SiO₂ 68.8%, Al₂O₃ 2.9%, Na₂O 14.2%, K₂O 0.2%, MgO 6.1%, CaO 7.8%

Each of the chemically strengthened glasses thus obtained was subjected to various evaluations. From CS value, DOL value and sheet thickness t (unit: μm) obtained by those evaluations, CT value based on the formula (3) was obtained. CT₁ value was obtained as CT₁=−38.7×ln(t/1000)+48.2 [MPa] from the sheet thickness t (unit: μm). The results are shown in Table 2.

TABLE 2

| | | Chemical strengthening step | | | | | | | | |
|---|---|---|---|---|---|---|---|---|---|---|
| | Sheet | KNO₃ | Strengthening | Strengthening | | | | | | Number of |
| | thickness t | concentration | time | temperature | CS | DOL | CT | CT₁ | CT₄ | fragments |
| | [μm] | [mass %] | [hour] | [° C.] | [MPa] | [μm] | [MPa] | [MPa] | [MPa] | [Number] |
| Ex. 34 | 77 | 100 | 48 | 400 | 524 | 22.4 | 365 | 147.4 | 515.1 | 2 |
| Ex. 35 | 77 | 100 | 72 | 400 | 462 | 34.5 | 1992 | 147.4 | 515.1 | >10 |
| Ex. 36 | 90 | 100 | 48 | 400 | 578 | 24.3 | 339 | 141.4 | 420.6 | 2 |
| Ex. 37 | 97 | 100 | 32 | 400 | 587 | 29.3 | 448 | 138.5 | 382.2 | >10 |
| Ex. 38 | 93 | 100 | 72 | 400 | 535 | 31.9 | 584 | 140.1 | 403.3 | >10 |
| Ex. 39 | 117 | 100 | 48 | 400 | 602 | 24.5 | 217 | 131.2 | 303.1 | 2 |
| Ex. 40 | 119 | 100 | 72 | 400 | 535 | 31.9 | 309 | 130.6 | 297.0 | >10 |
| Ex. 41 | 50 | 100 | 12 | 200 | 650 | 9.9 | 213 | 164.1 | 906.3 | 2 |

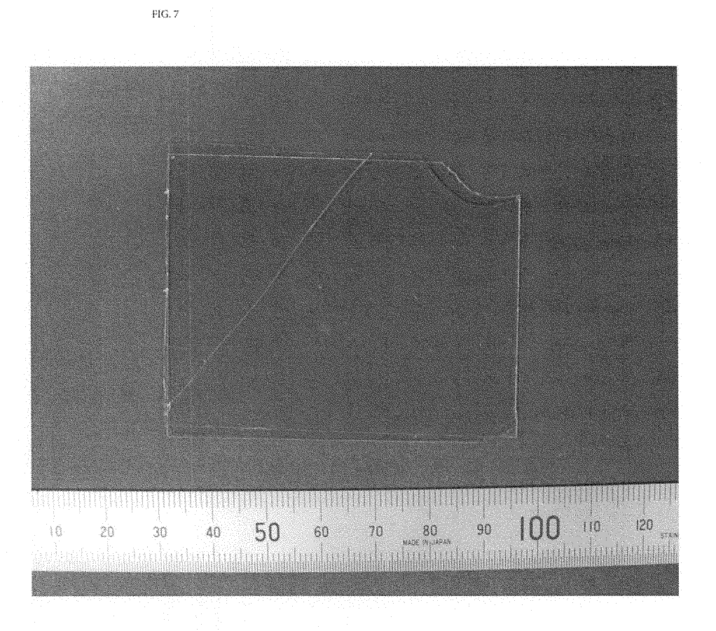

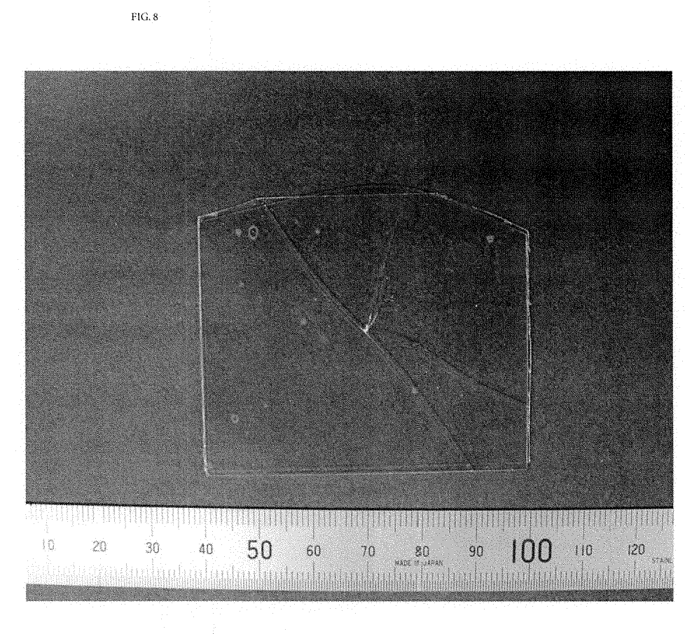

The relationship between a sheet thickness and internal tensile stress CT value in each sample of Tables 1 and 2 is plotted in FIG. 6. A curve corresponding to CT₁ value (broken line in the drawing) is also shown. In FIG. 6, the samples in which the number of fragments when fractured was 10 or less were plotted by ◯, and the samples in which the number of fragments when fractured exceeded 10 were plotted by x.

It was seen from the results of FIG. 6 that even in glass having CT value exceeding CT₁ value, the number of fragments when broken is sometimes small. This is considered due to the influence that because the indenter 110 used has sharp facing angle of the tip 111 of 60° and the indenter 110 is slowly (statically) pressed in the surface 210 of the chemically strengthened glass such that a load of 1.0 kgf (about 9.8N) is applied to the indenter in a rate of 60 μm/sec in the present test, even the sample having small sheet thickness t did not substantially warp.

The term “did not substantially warp” means the state that in the case where a load has been applied, glass temporarily warps at the moment of applying the load but warpage is not observed through the whole of the above test in the case of observing overall glass, that is, the state of the warpage-free glass intended in the present invention.

Therefore, in the chemically strengthened glass having small sheet thickness t, the value (upper limit) of CT that begins to finely fragment when glass has been broken under the condition that does not cause warpage greatly differs from CT₁ value that has conventionally be considered to be the upper limit. This is the phenomenon that was not seen in the case of observing cracking behaviors of a conventional chemically strengthened glass having large sheet thickness t and being difficult to warp and the chemically strengthened glass in the state having the influence of warpage (for example, by the collision of an indenter) even though the sheet thickness t is small.

On the other hand, it was understood from the results of FIG. 6 that when the internal tensile stress CT of the chemically strengthened glass exceeds a certain critical value that is different from CT₁ value, the number of fragments are increased when broken. The numerical value corresponding to the critical value can be approximated by a curve. The value of CT₄ (that is, the right side of the formula (4)) is shown in Tables 1 and 2 and a curve (solid line in the drawing) obtained by the above approximation is shown in FIG. 6, such that the cracking behaviors of the chemically strengthened glass having small sheet thickness t in the state free of the influence of warpage can be controlled. As shown in Tables 1 and 2 and FIG. 6, the number of fragments was large in the chemically strengthened glass having the internal tensile stress CT exceeding 4×(t/1000+0.02)⁻²+90 [MPa] in terms of the function of the sheet thickness t [μm]. Therefore, in the present description, the upper limit of the internal tensile stress CT was defined as CT₄=4×(t/1000+0.02)⁻²+90 [MPa] shown as the above solid line. When the internal tensile stress CT satisfies the formula (4), the glass is difficult to finely fragment when broken, and this is preferred. This condition has been found as a result of intensive investigations by the present inventors, and is the upper limit of the internal tensile stress CT of the chemically strengthened glass free of the influence of warpage.

### Examples 42 to 47

### (First Chemical Strengthening Step)

Soda lime glass (the composition is shown below) having a sheet thickness of 330 μm was subjected to slimming processing by an etching treatment to obtain soda lime glass of 50 mm×50 mm×230 μm t. Potassium nitrate (KNO₃) and sodium nitrate (NaNO₃) were added to an SUS cup such that the total amount of those is 3500 g and the concentration (mass %) of KNO₃ is as shown in the item of the first chemical strengthening treatment in Table 3, and heated to a predetermined temperature by a mantle heater to prepare a mixed molten salt of potassium nitrate and sodium nitrate. The soda lime glass was preheated to 425° C., dipped in the molten salt for a predetermined time, subjected to an ion exchange treatment, and then cooled to the vicinity of room temperature. Thus, a chemical strengthening treatment was conducted. The conditions of the chemical strengthening treatment are as shown in Table 3. The chemically strengthened glasses obtained were washed with pure water several times, and then dried by air blow. Thus, the chemically strengthened glasses of Examples 42 to 47 were obtained.

Soda lime glass (specific gravity: 2.50) composition (mol % expression): SiO₂ 68.8%, Al₂O₃ 2.9%, Na₂O 14.2%, K₂O 0.2%, MgO 6.1%, CaO 7.8%

Each of the chemically strengthened glasses thus obtained was subjected to various evaluations. From CS value, DOL value and sheet thickness t (unit: μm) obtained by those evaluations, CT value based on the formula (3) was obtained. From the sheet thickness t (unit: μm), CT₁ value was obtained as CT₁=−38.7×ln(t/1000)+48.2 [MPa], and the value of CT₄ was obtained as CT₄=4×(t/1000+0.02)⁻²+90 [MPa]. The results are shown in Table 3.

TABLE 3

| | | Chemical strengthening step | | | | | | | | |
|---|---|---|---|---|---|---|---|---|---|---|
| | Sheet | KNO₃ | Strengthening | Strengthening | | | | | | Number of |
| | thickness t | concentration | time | temperature | CS | DOL | CT | CT₁ | CT₄ | fragments |
| | [μm] | [mass %] | [hour] | [° C.] | [MPa] | [μm] | [MPa] | [MPa] | [MPa] | [Number] |
| Ex. 42 | 230 | 100 | 55 | 400 | 671 | 30.6 | 121.5 | 105.1 | 154.0 | 2 |
| Ex. 43 | 230 | 100 | 75 | 400 | 639 | 32.2 | 124.0 | 105.1 | 154.0 | 4 |
| Ex. 44 | 230 | 100 | 93 | 400 | 561 | 35.0 | 122.7 | 105.1 | 154.0 | 2 |
| Ex. 45 | 230 | 100 | 120 | 400 | 605 | 38.4 | 151.6 | 105.1 | 154.0 | 4 |
| Ex. 46 | 230 | 100 | 192 | 400 | 446 | 49.4 | 168.1 | 105.1 | 154.0 | 1000 |
| Ex. 47 | 230 | 100 | 264 | 400 | 466 | 58.1 | 238.2 | 105.1 | 154.0 | 5150 |

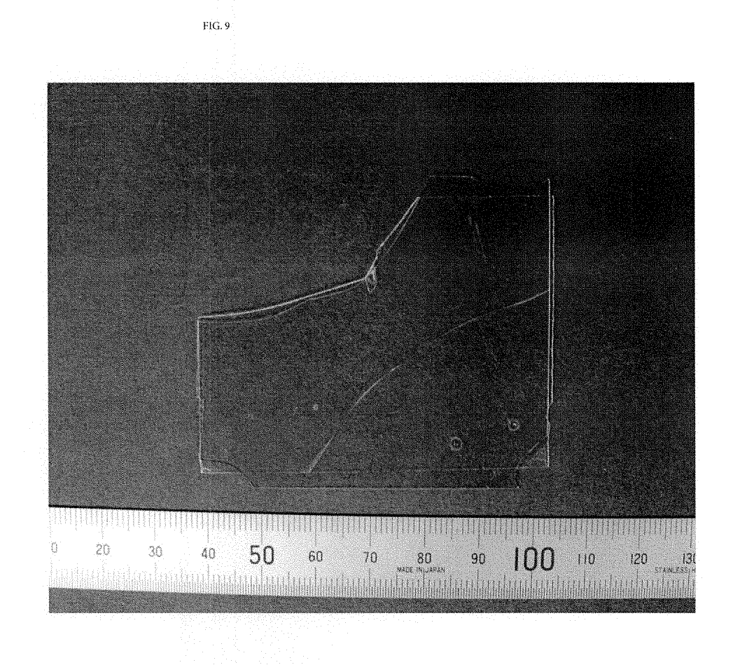

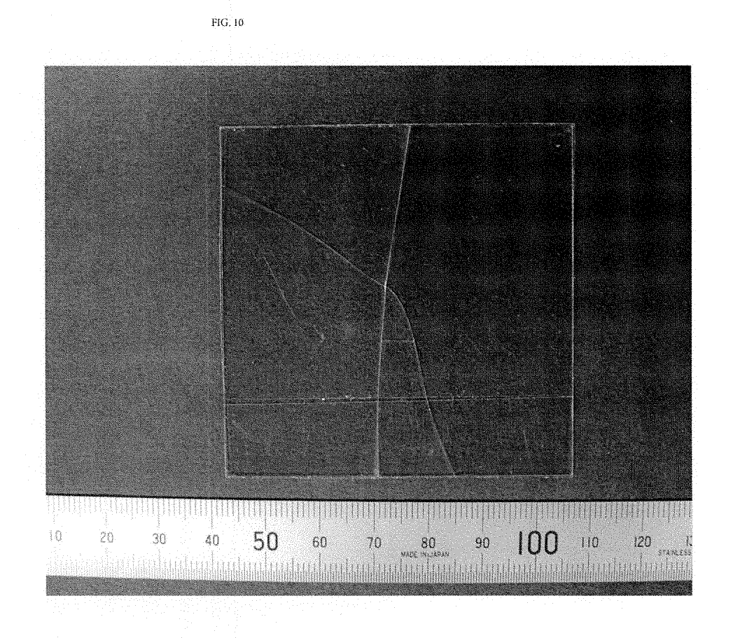

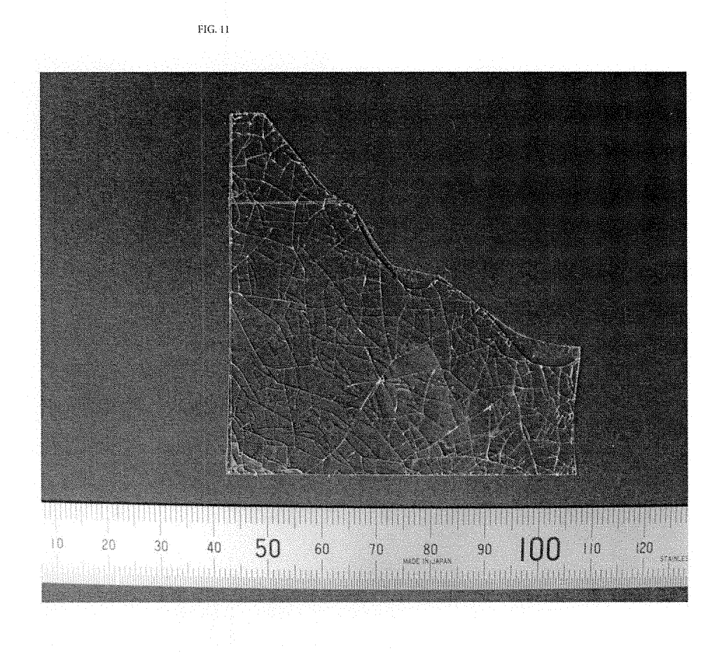

An indenter was pressed in the surface of each of the chemically strengthened glasses of Examples 42 to 45 such that a load of 1.0 kgf (about 9.8N) is applied to the indenter in a rate of 60 μm/sec, the state of having reached the load was maintained for 15 seconds, the load to the indenter was then removed, and the state after 15 seconds therefrom was observed. The photographs of those are shown in FIGS. 7 to 10, respectively. As shown in Table 3, the number of fragments of those chemically strengthened glasses was all 4 or less.

On the other hand, an indenter was freely dropped to the surface of each of the chemically strengthened glasses of Examples 42 to 45 from the height of 30 mm in the state that a weight of 10 g was attached to the indenter, the indenter was collided with the glasses in a rate of about 0.8 m/sec, and the state of the glasses was then observed. The number of fragments exceeded 10 in all cases.

Furthermore, an indenter having a facing angle of the tip of 136° was used, and the intender was pressed in the surface of each of the chemically strengthened glasses of Examples 42 to 45 in a rate of 60 μm/sec such that a load of 1.0 kgf (about 9.8 N) is applied to the indenter, the state of having reached the load was maintained for 15 seconds, the load on the indenter was then removed, and the state after 15 seconds therefrom was observed. The number of fragments exceeded 10 in all cases.

The difference in the cracking behaviors greatly depends on a pressing rate of an indenter and a facing angle of a tip of an indenter. When an indenter is pressed in chemically strengthened glass in high rate or an indenter having large facing angle of a tip thereof is used, thin chemically strengthened glass warps similar to the case of collision. Therefore, the influence of dynamic compressive stress and tensile stress cannot be disregarded. Due to this, the chemically strengthened glasses of Examples 42 to 45 are finely broken regardless of relatively low CT.

On the other hand, when an indenter is pressed in low rate (for example, a rate of 60 μm/sec), a chemically strengthened glass does not substantially warp. As a result, the chemically strengthened glasses of Examples 42 to 45 do not finely break. This artificially reproduces the environment that the chemically strengthened glass is brought into contact with a material to be covered and is difficult to warp.

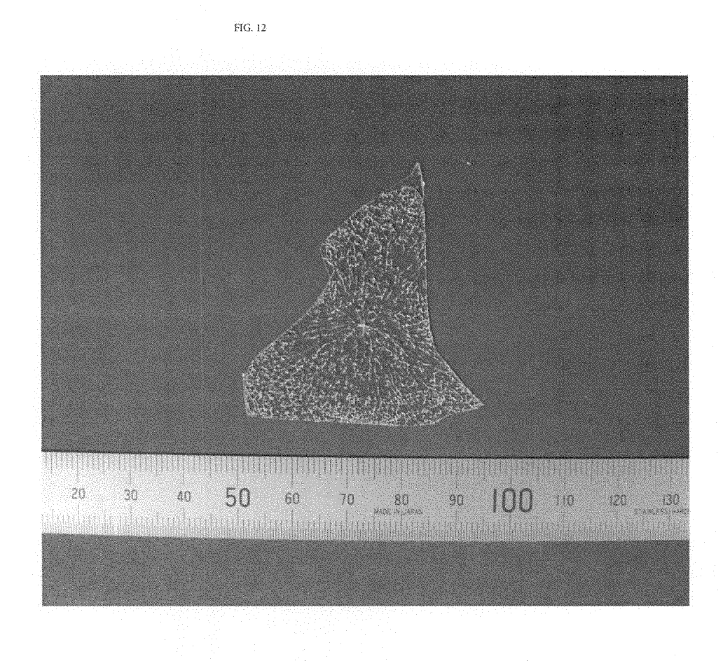

An indenter was pressed in the surface of each of the chemically strengthened glasses of Examples 46 and 47 such that a load of 1.0 kgf (about 9.8N) is applied to the indenter in a rate of 60 μm/sec, the state of having reached the load was maintained for 15 seconds, the load to the indenter was then removed, and the state after 15 seconds therefrom was observed. The photographs of those are shown in FIGS. 11 and 12, respectively. As shown in Table 3, the number of fragments of those chemically strengthened glasses was all 1000 or more. In the case where the internal tensile stress CT is large enough not satisfying the formula (4), it is understood that the glass is finely broken regardless of the presence or absence of the influence of warpage.

From those results, even in a chemically strengthened glass having small sheet thickness t, cracking behaviors of the chemically strengthened glass under the condition where warpage is difficult to occur can be controlled by controlling the internal tensile stress CT within a numerical range satisfying the formula (4).

Although the preferred embodiments and Examples have been described in detail, those are not limited to the above-described embodiments and Examples, and various modifications or changes can be added to the embodiments and Examples without departing the scope recited in the claims. The above embodiments can be appropriately combined. This application is based on Japanese Patent Application (Application No. 2015-158843) filed on Aug. 11, 2015, the entire of which is incorporated. The contents cited in the application are incorporated herein by reference in its entirety.

### DESCRIPTION OF REFERENCE NUMERALS AND SIGNS

100 Vickers harness tester
110 Indenter
111 Tip
200 Chemically strengthened glass
210 Surface of chemically strengthened glass

1. A chemically strengthened glass
having a sheet thickness of less than 300 μm,
having a surface compressive stress of 200 MPa or more and
satisfying CT≤4×(t/1000+0.02)⁻²+90, wherein an internal tensile stress is CT (MPa) and the sheet thickness is t (μm).

2. The chemically strengthened glass according to claim 1, satisfying CT>−38.7×ln(t/1000)+48.2, wherein the internal tensile stress is CT (MPa) and the sheet thickness is t (μm).

3. The chemically strengthened glass according to claim 1, having a depth of a compressive stress layer of 3 μm or more.

4. The chemically strengthened glass according to claim 1, having a depth of a compressive stress layer of 50 μm or less.

5. The chemically strengthened glass according to claim 1, having a surface roughness Ra of a surface of the chemically strengthened glass of 1 to 300 nm.

6. The chemically strengthened glass according to claim 5, wherein the surface roughness Ra is controlled by a slimming processing.

7. The chemically strengthened glass according to claim 1, comprising, expressed by mol % on the basis of oxides, 64 to 72% of SiO₂, 10 to 18% of Na₂O, 0 to 5% of K₂O, and 1 to 9% of Al₂O₃, wherein a ratio of (Na₂O+K₂O)/Al₂O₃ is 1.8 to 5.

8. The chemically strengthened glass according to claim 1, wherein the chemically strengthened glass is to be used by being brought into contact with, through an adhesive layer, a material to be covered having a bending rigidity larger than that of the chemically strengthened glass.
